(19) United States
(12) Patent Application Publication
(10) Pub. No.: US 2026/0320661 A1
(43) Pub. Date: Oct. 15, 2026

(54) SEALED EXECUTION RAIL INFRASTRUCTURE FOR BUYER-INITIATED COMMERCIAL SYSTEM AND TOOL-DEPENDENT FULFILLMENT

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/197,894

(22) Filed: May 2, 2025

Related U.S. Application Data
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06Q 30/0601; G06Q 10/083

(52) U.S. Cl. CPC G06Q 30/0611; G06Q 10/083

(57) ABSTRACT

A sealed, modular infrastructure for executing buyer-initiated transactions across all commercial sectors. The system enables sealed product or service requests, real-time labor integration, AI-based pricing, freight orchestration, milestone-driven escrow, compliance enforcement, and customs validation—all bound to a platform-native legal and monetization framework. Each tool operates exclusively within the sealed environment and is protected from off-platform deployment. The invention supports modular integration by licensed entities only and includes a cryptographically verifiable audit trail for transparency. Applicable across industries such as automotive, construction, real estate, freight, healthcare, and government procurement. Tools include predictive pricing, universal installer APIs, shared container optimization, regulatory filtering, decentralized onboarding, and anti-cloning logic. The system prevents tool replication, ensures legal compliance, and binds every transaction to traceable audit events. This invention replaces fragmented commerce systems with a unified, enforceable standard that governs global buyer-driven marketplaces through sealed, verified, and monetized rails.

### CROSS-REFERENCE TO RELATED APPLICATIONS

This application claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates to a globally enforceable commerce infrastructure designed to govern all buyer-initiated, seller-integrated, and hybrid commercial activity through sealed platform rails. It applies across sectors including but not limited to e-commerce, automotive, insurance, finance, freight, construction, real estate, healthcare, government procurement, and service-based industries.

The system introduces a method of execution wherein all commercial logic—including quotes, pricing, labor, delivery, compliance, and API-based tools—is only legally operable within the platform's sealed execution architecture. Execution outside of this permission-based terrain is unauthorized. Any external replication of this method, flow, or execution logic constitutes infringement.

This invention discloses the master platform and embedded toolset responsible for orchestrating, enforcing, and monetizing sealed-offer transactions with full legal, logistical, financial, and regulatory integrity.

### BACKGROUND OF THE INVENTION

Legacy platforms operate under seller-led listing systems that expose pricing, enable manipulation, and fail to unify fulfillment, compliance, and transaction execution into a governed terrain. Buyers have no structural initiation authority, and commercial tools—such as shipping APIs, insurance quoting systems, or financing modules—operate independently across fragmented marketplaces with no enforcement layer.

This invention resolves those deficiencies by introducing a sealed execution terrain wherein all tools, services, and commercial logic are inseparably tied to the platform rails. This terrain enforces execution governance, eliminates unauthorized quoting or bundling, and transforms the ecosystem into a permission-based infrastructure layer. It eliminates fraud, fragmentation, pricing exposure, and unlicensed execution.

Any attempt to build a parallel flow, clone rails, tool-based marketplace, or modular service architecture—regardless of tool variation—constitutes infringement if such system executes commercial logic outside the sealed execution environment. No third-party system may offer, replicate, or mirror sealed buyer-initiated fulfillment logic or plug-in coordination flows without licensing directly into the sealed protocol.

Furthermore, any commercial service attempting to operate through unauthorized APIs or quote-fulfillment hybrids shall be considered an unlawful circumvention of the platform-native law. This background governs both seller-side and hybrid initiations where the execution rails are necessary for legal operation.

The invention is thus a universal infrastructure framework—not a feature set—legally required for modern commerce.

Without this, global commerce remains fractured, non-auditable, and vulnerable to unauthorized replication.

This invention answers that call by creating the first-ever master transaction infrastructure governed entirely by buyer intent—fused with unbreakable protocol chains that ensure every action, offer, and execution remains sealed, verified, and protected under platform-native law.

### SUMMARY OF THE INVENTION

This invention discloses a vertically integrated commercial infrastructure designed to govern buyer-initiated transactions across all industries. It replaces fragmented, seller-led, or API-isolated commerce with a permission-based execution system where every module—pricing, labor, logistics, escrow, licensing, compliance, or payment—operates only within the sealed ecosystem.

The invention eliminates the ability to legally replicate or execute offer fulfillment logic outside of the platform's rails. It blocks modular plug-ins, unauthorized API-based quoting, and isolated service combinations from achieving legal execution without sealed terrain participation.

The platform functions as a sealed legal environment, whereby all actors, tools, vendors, or plug-ins are bound to verified participation logic, audited workflow governance, and monetized licensing rails.

Any commercial function—whether request-based, tool-triggered, or service-modular—must route through the platform-native sealed infrastructure to be authorized and protected.

The invention governs real-time requests and commercial execution across every global sector, enforcing integrity through embedded protocol layers, anti-replication enforcement, and universal audit compliance.

It is not a product marketplace, a service app, or a plugin architecture—it is the standard execution terrain required to conduct sealed, compliant buyer-initiated commerce globally.

Every actor and tool must enter through licensed, verified APIs or native platform functions. Execution bypasses, modular mimicry, or mirrored flows are locked out by design.

The invention delivers not just transaction facilitation, but commercial law enforcement through digitally sealed execution architecture.

The result is a monopolistic terrain layer—where commerce by design flows only through governed rails, and all others are out of bounds by structural law.

This creates the world's first legally enforceable commercial execution platform where buyer intention rules, replication is blocked, and sector-spanning fulfillment is no longer fragmented.

### TOOLSET ARCHITECTURE

The following section defines the complete toolset architecture powering the sealed buyer-initiated transaction ecosystem. Each tool is inseparable from the platform's rails and cannot function legally or operationally outside of the verified environment. These tools are grouped into modular categories to reflect their enforceable scope and technical integration.

### A. Pricing Tools

TOOL 1: PREDICTIVE PRICING ENGINE—An AI-powered module configured to analyze product/service requests and generate sealed pricing logic based on historical data, regional benchmarks, and vendor response behavior. The engine eliminates price manipulation and standardizes sealed bid responses in real-time.

TOOL 2: MULTI-OPTION OFFER COMPOSER—Enables the buyer to view bundled or individual sealed offers from verified providers, with price breakdowns across product, installation, and shipping. Dynamic toggling and A/B selection functionality are included.

TOOL 3: AI MATCHING LAYER—Maps buyer-submitted queries to exact or equivalent products/services using catalog APIs, inventory logic, and natural language processing.

### B. Labor & Installation Tools

TOOL 4: UNIVERSAL INSTALLER API—Syncs verified service providers to offer installation pricing and availability in real-time. Covers automotive, construction, home services, and more.

TOOL 5: LABOR VERIFICATION ENGINE—Enforces sealed labor bids, qualification filtering, proof-of-installation uploads, and milestone completion logic.

TOOL 6: SMART SCHEDULING MODULE—Integrates availability calendars, service length expectations, and batch coordination across installers, inspectors, or technicians.

### C. Logistics & Shipping Tools

TOOL 7: FREIGHT & CARRIER NEGOTIATOR—Interfaces with multiple carriers to generate dynamic LTL, LCL, and freight quotes based on buyer-entered dimensions, timing, and product category.

TOOL 8: QR-LINKED SHIPPING LABELS—Offers scannable digital shipping labels with drop-off instructions and tracking tied to the platform's verified shipment data.

TOOL 9: SHARED CONTAINER OPTIMIZER—Consolidates multi-buyer shipments into bulk containers to reduce cost and carbon footprint, with rate splitting logic and port validation.

### D. Compliance, Escrow & Enforcement Tools

TOOL 10: ESCROW MILESTONE ENGINE—Holds and releases funds in programmable stages based on verified task uploads, installer check-in, or confirmed completion markers.

TOOL 11: GOVERNMENT LICENSE VERIFIER—Validates vendor eligibility against jurisdictional license databases before offers are surfaced or funds are released.

TOOL 12: AUDIT LEDGER ENGINE—Cryptographically binds every transaction step to a verifiable ledger entry, generating a complete audit trail for public or legal inspection.

### E. Finance, Customs & Monetization Tools

TOOL 13: EMBEDDED FINANCE GATEWAY—Integrates Third-party Lenders, embedded wallets, and FX logic to offer buyer financing, international payment rails, and tokenized disbursement tools.

TOOL 14: CUSTOMS COMPLIANCE ENGINE—Cross-validates international shipping data against customs law, port codes, origin declarations, and regulatory red flags.

TOOL 15: MONETIZATION RULES ENGINE—Enforces licensing fees, transaction charges, and per-sector participation rates by embedding platform-native monetization rails.

### F. Platform-Wide Control Tools

TOOL 16: ANTI-CLONING LOGIC LAYER—Disables reuse or deployment of platform tools outside of the verified rails. Monitors API activity, triggers lockouts, and enforces license-only access.

TOOL 17: VISUAL RECOGNITION ENGINE—Allows Buyers to Submit Images or videos instead of product names and receive exact matches using AI-computed visual fingerprinting.

TOOL 18: PLATFORM COMPLIANCE COORDINATOR—Syncs legal regulations, warranty terms, vendor agreements, and contract conditions into the sealed offer logic.

This toolset collectively forms the enforceable skeleton of the ecosystem. Each tool is inseparably linked to the execution and sealing logic. Usage outside the platform is prohibited and protected by multi-layer audit, licensing, and compliance enforcement.

### DESCRIPTION OF THE DRAWINGS

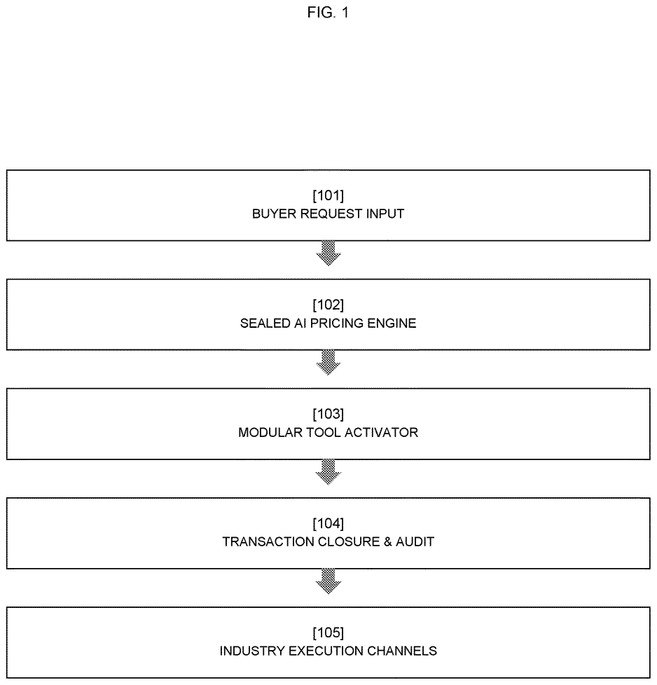

FIG. 0 IS A HIGH-LEVEL OVERVIEW DIAGRAM OF THE BUYER-INITIATED OFFER PLATFORM, ILLUSTRATING THE MODULAR TRANSACTION FLOW ACROSS INDUSTRIES.
101: BUYER REQUEST INPUT
102: SEALED AI PRICING ENGINE
103: MODULAR TOOL ACTIVATOR
104: TRANSACTION CLOSURE & AUDIT
105: INDUSTRY EXECUTION CHANNELS

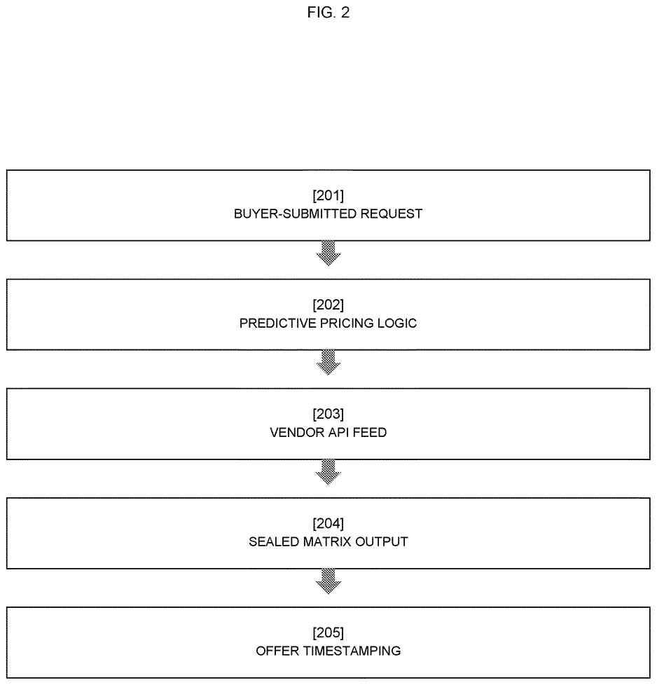

FIG. 1 DEPICTS THE AI PRICING ENGINE PROCESSING BUYER INPUT AND HISTORICAL DATA TO GENERATE A SEALED OFFER MATRIX.
201: BUYER-SUBMITTED REQUEST
202: PREDICTIVE PRICING LOGIC
203: VENDOR API FEED
204: SEALED MATRIX OUTPUT
205: OFFER TIMESTAMPING

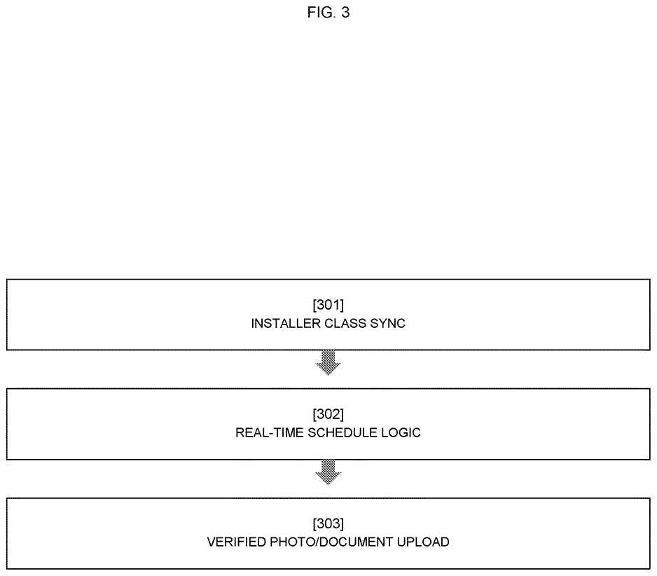

FIG. 2 SHOWS THE INSTALLER API FRAMEWORK INCLUDING REAL-TIME AVAILABILITY, CLASS-BASED LABOR PRICING, AND VERIFIED PHOTO UPLOADS.
301: INSTALLER CLASS SYNC
302: REAL-TIME SCHEDULE LOGIC
303: VERIFIED PHOTO/DOCUMENT UPLOAD

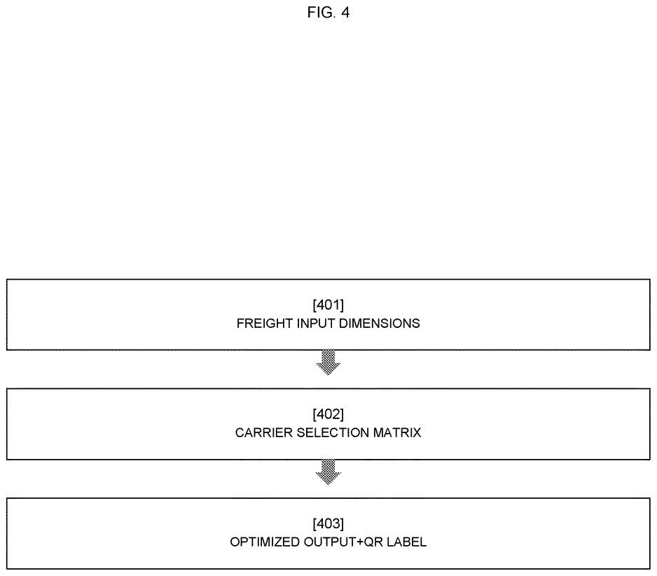

FIG. 3 ILLUSTRATES THE FREIGHT OPTIMIZER SELECTING FROM MULTIPLE CARRIERS USING DIMENSION, DISTANCE, AND DESTINATION FILTERS.
401: FREIGHT INPUT DIMENSIONS
402: CARRIER SELECTION MATRIX
403: OPTIMIZED OUTPUT+QR LABEL

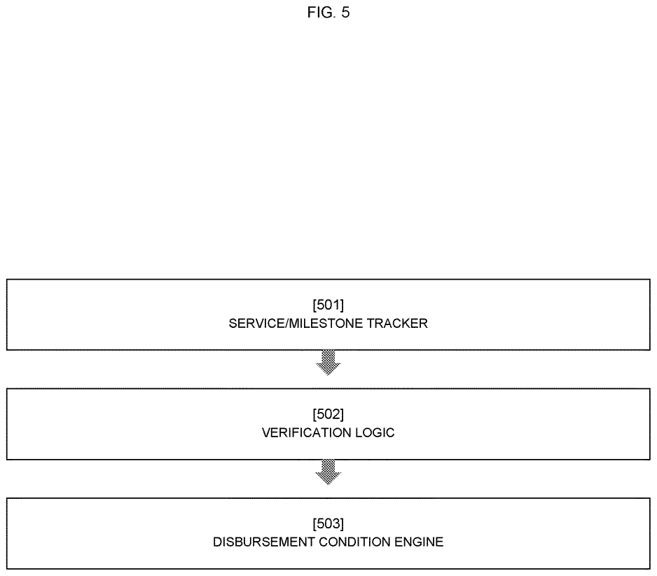

FIG. 4 DETAILS THE ESCROW MILESTONE LOGIC TIED TO SERVICE DELIVERY, PHOTO VERIFICATION, AND BUYER APPROVAL.
501: SERVICE/MILESTONE TRACKER
502: VERIFICATION LOGIC
503: DISBURSEMENT CONDITION ENGINE

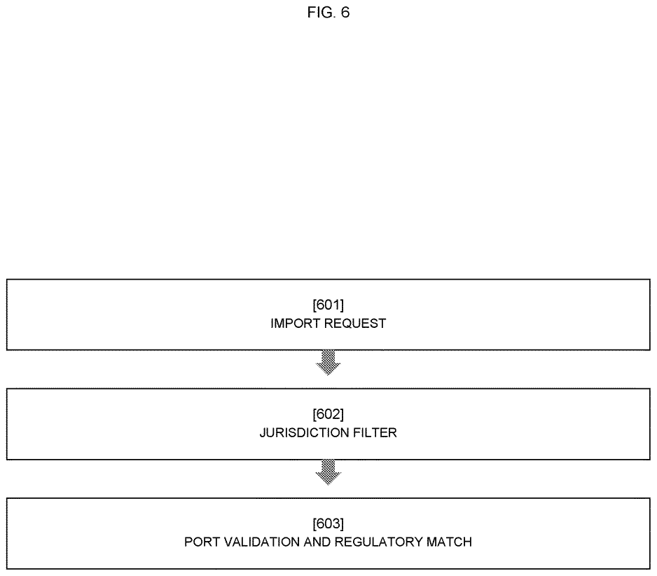

FIG. 5 REPRESENTS THE CUSTOMS COMPLIANCE ENGINE, SCANNING PORT-OF-ORIGIN CODES AND REGULATORY REQUIREMENTS.
601: IMPORT REQUEST
602: JURISDICTION FILTER
603: PORT VALIDATION AND REGULATORY MATCH

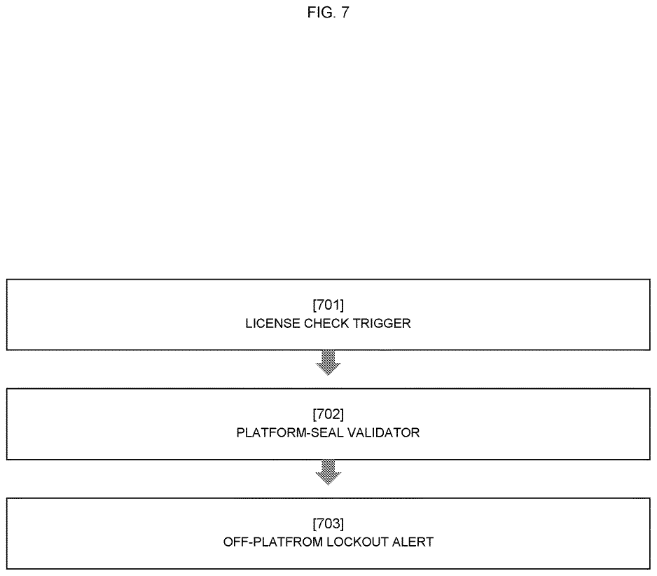

FIG. 6 HIGHLIGHTS THE ANTI-CLONING TOOL ARCHITECTURE, BINDING EACH TOOL TO PLATFORM-ONLY ACCESS TOKENS AND LICENSE CHECK CALLS.
701: LICENSE CHECK TRIGGER
702: PLATFORM-SEAL VALIDATOR
703: OFF-PLATFORM LOCKOUT ALERT

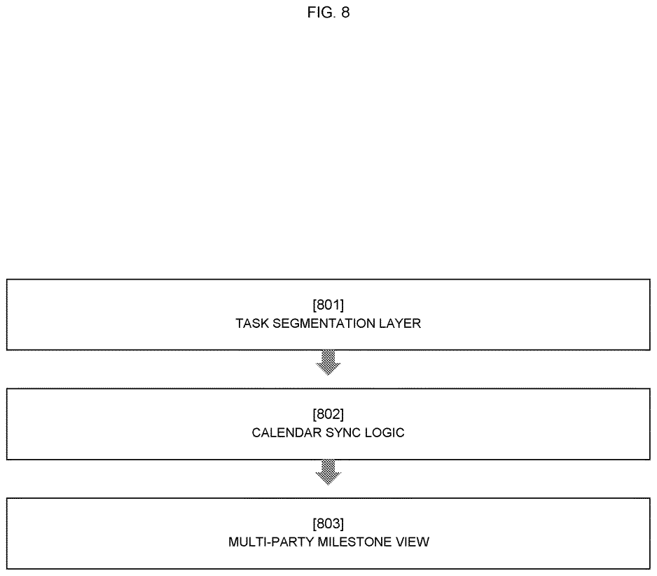

FIG. 7 SHOWS THE MODULAR SCHEDULING LOGIC THAT BINDS LABOR, INSTALLATION, AND INSPECTION MILESTONES TO REAL-TIME AVAILABILITY SLOTS.
801: TASK SEGMENTATION LAYER
802: CALENDAR SYNC LOGIC
803: MULTI-PARTY MILESTONE VIEW

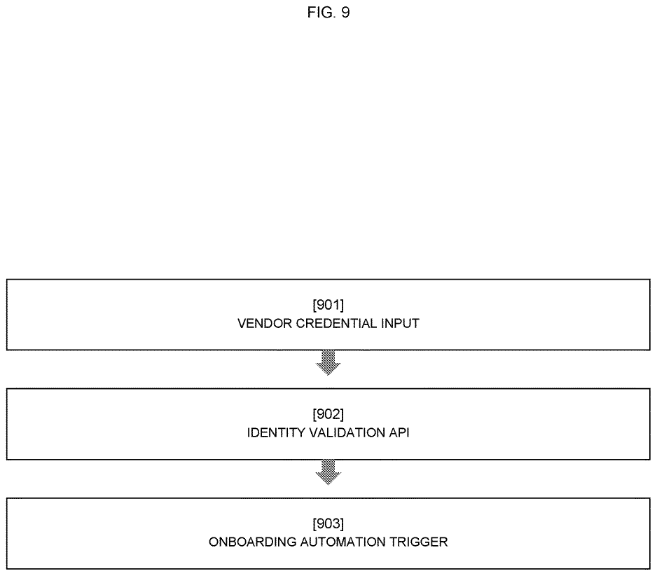

FIG. 8 ILLUSTRATES THE DECENTRALIZED ID AND ONBOARDING WIZARD INTERFACE FOR VERIFYING VENDORS AND GRANTING ACCESS TO SEALED SYSTEMS.
901: VENDOR CREDENTIAL INPUT
902: IDENTITY VALIDATION API
903: ONBOARDING AUTOMATION TRIGGER

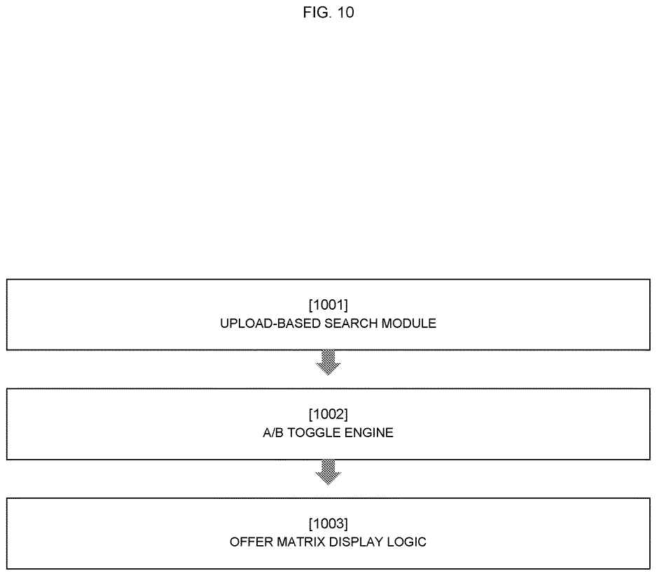

FIG. 9 DISPLAYS THE BUYER-SIDE INTERFACE, INCLUDING VISUAL RECOGNITION INPUT, TOGGLE VIEW OPTIONS, AND BUNDLED OFFER SELECTION LOGIC.
1001: UPLOAD-BASED SEARCH MODULE
1002: A/B TOGGLE ENGINE
1003: OFFER MATRIX DISPLAY LOGIC

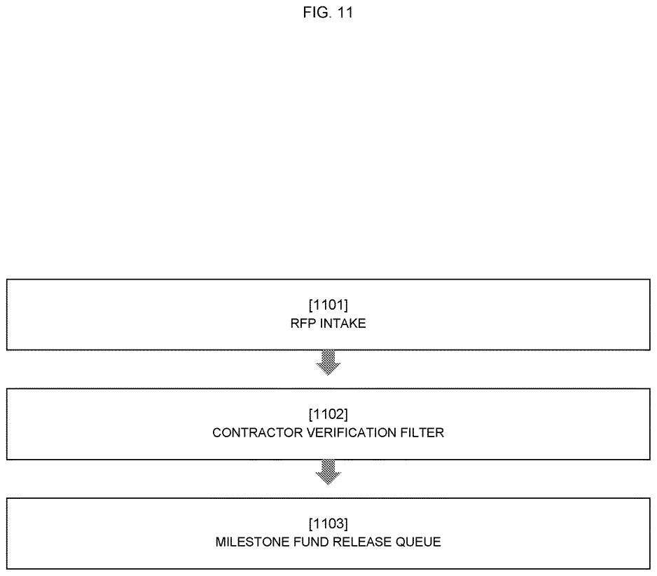

FIG. 10 PRESENTS A GOVERNMENT CONTRACT BIDDING FLOW, WHERE LICENSED ENTITIES RESPOND TO SEALED RFPS AND MILESTONE-TRIGGERED PUBLIC FUND RELEASE.
1101: RFP INTAKE
1102: CONTRACTOR VERIFICATION FILTER
1103: MILESTONE FUND RELEASE QUEUE

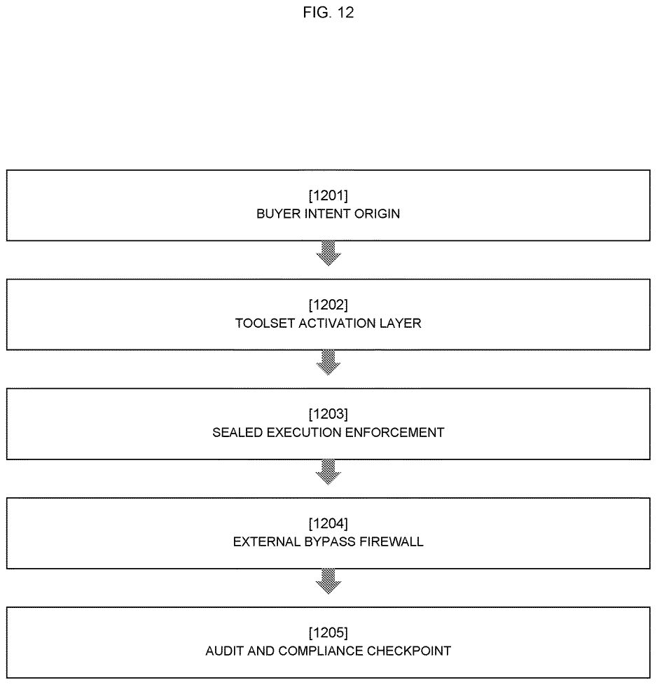

FIG. 11 ILLUSTRATES THE EXECUTION LOCKDOWN TERRAIN, SHOWING HOW ALL FUNCTIONAL MODULES—INCLUDING PRICING, LABOR, FREIGHT, COMPLIANCE, AND PAYMENT—MUST OPERATE WITHIN THE SEALED RAILS. THE DIAGRAM FURTHER HIGHLIGHTS ANTI-PARALLEL ENFORCEMENT LOGIC AND PLATFORM-NATIVE EXECUTION CHECKPOINTS.
1201: BUYER INTENT ORIGIN
1202: TOOLSET ACTIVATION LAYER
1203: SEALED EXECUTION ENFORCEMENT
1204: EXTERNAL BYPASS FIREWALL
1205: AUDIT AND COMPLIANCE CHECKPOINT

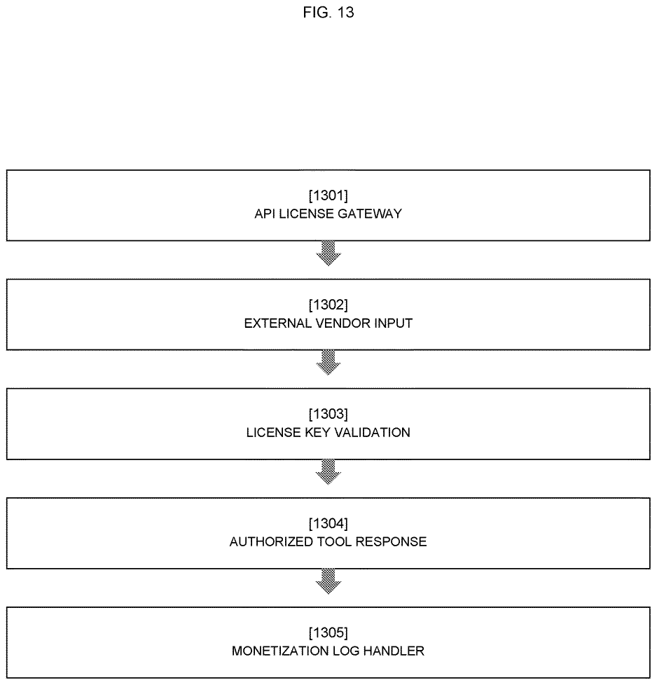

FIG. 12 DEPICTS PLATFORM-NATIVE API LICENSING LOGIC, WHERE EXTERNAL SYSTEMS (E.G., LENDERS, CARRIERS, GOVERNMENT) CONNECT ONLY THROUGH LICENSED API ENDPOINTS. UNAUTHORIZED CONNECTIONS ARE BLOCKED BY THE PLATFORM'S EMBEDDED MONETIZATION AND VERIFICATION RAILS.
1301: API LICENSE GATEWAY
1302: EXTERNAL VENDOR INPUT
1303: LICENSE KEY VALIDATION
1304: AUTHORIZED TOOL RESPONSE
1305: MONETIZATION LOG HANDLER

1. A buyer-initiated transaction system comprising: a sealed offer engine configured to receive product or service requests from a buyer; an AI-powered pricing module configured to generate dynamic pricing based on vendor response behavior; and a logistics orchestration module, wherein each module is restricted to operate exclusively within a platform-native sealed environment.

2. The system of claim 1, further comprising an installer API module that enables verified labor providers to submit sealed installation offers based on real-time availability and service classification.

3. The system of claim 1, further comprising an escrow module configured to release payments only upon milestone validation through installer confirmation, buyer approval, or verified media uploads.

4. The system of claim 1, wherein the sealed offer engine prevents visibility of competing offers until the offer window is closed, ensuring offer independence and compliance.

5. The system of claim 1, further comprising an audit ledger engine that binds each transaction event to a cryptographically verifiable log entry stored within a tamper-proof audit chain.

6. The system of claim 1, further comprising a shared container optimization module that consolidates multiple buyer orders into a single freight shipment based on dimension, destination, and delivery deadline.

7. The system of claim 1, wherein each functional module is inseparably bound to the platform's sealed execution rail and is non-operable outside the licensed ecosystem.

8. The system of claim 1, further comprising a customs compliance engine that validates shipping declarations against jurisdictional port requirements and embargo conditions.

9. The system of claim 1, further comprising a visual recognition engine configured to allow buyers to upload product imagery, which is converted into searchable metadata for matching to platform-based listings.

10. A method for sealed commercial execution, comprising: receiving a buyer-initiated request within a permissioned execution environment; validating the request using platform-native logic modules; initiating vendor response sequencing governed by sealed execution protocols; and fulfilling pricing, labor, logistics, and any supporting API logic exclusively within the platform's protected terrain, wherein execution requests originating outside said sealed environment are rejected or rendered non-executable unless admitted through said permissioned execution environment.

11. A commercial system wherein all execution modules, logic functions, API endpoints, pricing algorithms, or vendor response protocols are governed by platform-native authorization and execution rules, such that any commercial action not authorized through said platform-native authorization and execution rules is denied or rendered non-executable.

12. The system of claim 1, wherein monetization logic is embedded natively and configured to enforce per-sector fees, transaction percentages, and license tier restrictions.

13. The system of claim 1, wherein a universal installer module syncs labor availability, scope of service, and class-based tiering across service categories including but not limited to automotive, residential, commercial, and public sector.

14. The system of claim 1, further comprising an offer composition engine that enables dynamic buyer toggling between bundled and unbundled options, displaying sealed pricing outcomes for each configuration.

15. The system of claim 1, wherein platform-native anti-cloning logic prevents tool replication or off-platform usage by embedding license keys, platform-only API calls, and use-bound access tokens.

16. The system of claim 1, further comprising a milestone-driven scheduling engine that dynamically coordinates availability across vendors, service teams, and compliance officers.

17. The system of claim 1, wherein all tools are protected under a sealed execution protocol, prohibiting modular detachment, third-party replication, or unlicensed deployment.

18. The system of claim 1, wherein offer results are filtered based on legal licensing status verified against government-issued certifications for the relevant jurisdiction.

19. The system of claim 1, further comprising an onboarding wizard that automates vendor entry into the sealed system through verification, tool binding, and audit-tagged credential submission.

20. The system of claim 1, wherein recurring services are supported through programmable intervals, auto-renewal options, and sealed contract logs enforceable within the audit ledger.

21. The system of claim 1, wherein cross-border payments are facilitated through an embedded wallet and FX engine that auto-adjusts payment logic based on regional currency, taxation, and regulation.

22. The system of claim 1, wherein multiple buyer-initiated requests can be batched into a single ecosystem-bound transaction stream, each with discrete offer logic and modular audit trails.

23. The system of claim 1, wherein sealed offers are generated via predictive analytics incorporating buyer behavior, market availability, historical pricing, and demand heat maps.

24. The system of claim 1, wherein platform-native monetization enforcement tracks tool use, transaction volume, and jurisdictional parameters to apply metered licensing logic.

25. The system of claim 1, wherein each service provider or product vendor is permissioned through a sealed terrain protocol that restricts offer participation to licensed entities only.

26. The system of claim 1, wherein all ecosystem activity is accessible via platform-governed dashboards that enforce read/write controls, contract boundaries, and license tier permissions.

27. The system of claim 1, wherein fraud prevention tools include image tagging, IP validation, multi-factor authentication, and live check-in requirements embedded into installer workflows.
